(19) United States
(12) Patent Application Publication
(10) Pub. No.: US 2008/0010245 A1
(43) Pub. Date: Jan. 10, 2008

(54) METHOD FOR CLUSTERING DATA BASED CONVEX OPTIMIZATION

(76) Inventors: Jaehwan Kim, Incheon (KR); Kwang Hyun Shim, Daejeon (KR); Hun Joo Lee, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/774,194

(22) Filed: Jul. 6, 2007

(30) Foreign Application Priority Data
Jul. 10, 2006 (KR) 10-2006-0064551
Jun. 12, 2007 (KR) 10-2007-0057223

(51) Int. Cl. G06F 17/30

(52) U.S. Cl. 707/2

(57) ABSTRACT

A method for clustering data based convex optimization is provided. The method includes the steps of: obtaining an optimal feasible solution that satisfies given strong duality using convex optimization for an objective function; and clustering data by extracting eigenvalue from the obtained optimal feasible solution.

### BACKGROUND OF THE INVENTION

1. Field of the Invention

The present invention relates to a method for clustering data based on convex optimization, and more particularly, to a method for clustering data based on convex optimization, which can provide an ideal clustering result by applying graph multi-way partition for conventional assignment problems and graph partition problems and through semidefinite relaxation.

2. Description of the Related Art

Cluster analysis is one that has been studied for very long time among machine learning fields. Various cluster analysis methods have been introduced and substantially applied in many fields. For example, the cluster analysis was applied for segmenting images in a computer vision field, for analyzing data in medical and marketing fields, for clustering documents, and for clustering data to analyze biological data. Also, the cluster analysis has been applied for clustering web-pages on a network, clustering clients, and clustering crowds in crowd simulation.

The object of data clustering is to naturally group data through measuring the similarity and the difference of the data with no information about the data provided.

As a conventional data clustering method, a data clustering method using adjacent data such as a k-nn algorithm and a centroid-base clustering method such as a k-means algorithm and an expectation maximization (EM) algorithm have been introduced. Such a centroid based clustering has limitation that the distribution of each cluster must be assumed as predetermined distribution, for example, normal distribution.

In order to overcome the limitation of the centroid-based clustering method, a spectral graph theory was introduced, and there were many researches in progress for developing the related methods, for example, a spectral clustering. In the conventional spectral clustering method, data is clustered by transforming an original clustering problem into a low-dimensional space using the maximum or the minimum eigenvectors of an affinity matrix that represents the similarity between data to cluster. However, the conventional spectral clustering method is a Non-deterministic Polynomial-time hard (NP-hard) combinational problem and a non-convex problem. Also, a proper optimization method thereof was not introduced. Therefore, the conventional spectral clustering method provides only a local solution. That is, it is difficult to obtain the ideal clustering result using the conventional spectral clustering method because a feasible set providing the solution and an objective function defined above the feasible set are not optimized.

The graph partitioning method, one of the NP-hard combination problems, has been actively studied for long time in a combinatorial optimization field among pure mathematics.

Meanwhile, the graph spectral based clustering performance is directly influenced by whether a graph Laplacian matrix, a stochastic matrix, or a data-driven kernel matrix has a well-formed block diagonal matrix structure or not. If it is assumed that different sub clusters are separated infinitely, the graph Laplacian matrix formed therefrom has the exact diagonal matrix structure, and it is one of factors to have the ideal clustering result.

Since noises or artifacts are generally present between given data, and a distance between different sub clusters is finite, a matrix used for clustering data does not have the exact diagonal matrix structure, and eigenvectors obtained therefrom also have oscillation. Therefore, these factors badly influence the clustering performance.

### SUMMARY OF THE INVENTION

Accordingly, the present invention is directed to a method for clustering data using convex optimization, which substantially obviates one or more problems due to limitations and disadvantages of the related art.

It is an object of the present invention to provide a method for clustering data based on convex optimization, which can improve the clustering performance by making a matrix directly related to the generation of eigenvector used for clustering to have a block diagonal structure using semidefinite relaxation.

It is another object of the present invention to provide a method for clustering data based on convex optimization, which can improve the graph spectral based clustering performance by obtaining an optimal feasible solution using a matrix with the strong duality for graph multi-way partitioning well-reflected in semidefinite relaxation.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for clustering data based on convex optimization including the steps of: obtaining an optimal feasible solution that satisfies given strong duality using convex optimization for an objective function; and clustering data by extracting eigenvalue from the obtained optimal feasible solution.

Semidefinite relaxation may be used as the convex optimization; the optimal feasible solution may be an optimal feasible matrix obtained using the semidefinite programming and an optimal partition matrix obtained from the optimal feasible matrix.

The semidefinite relaxation may includes the steps of a) obtaining a dual function by obtaining a Lagrangian that satisfy the objective function and the strong duality; b) determining whether the storing duality is satisfied by relaxed standard semidefinite programming obtained by relaxing the semidefinite programming; and c) obtaining an optimal partition matrix through an interior-point method if the strong duality is satisfied. An optimal partition matrix may be calculated using a barycenter-based method with a barycenter matrix of a convex hull for partition matrices if the strong duality is not satisfied.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is an overall flowchart illustrating a method for clustering data based on convex optimization according to an embodiment of the present invention;

FIG. 2 is a flowchart illustrating the optimization step using semidefinite programming for obtaining an optimal feasible matrix in the method for clustering data using convex optimization according to an embodiment of the present invention;

FIG. 3 is a flowchart illustrating the clustering step from the optimal feasible matrix in the method for clustering data using convex optimization according to an embodiment of the present invention; and

FIG. 4 is a diagram illustrating a simulation result for clustering data for graph multi-way partition that satisfies uniform distribution strong duality defined by a user based on FIG. 1 to FIG. 3.

### DETAILED DESCRIPTION OF THE INVENTION

Reference will now be made in detail to the preferred embodiments of the present invention, examples of which are illustrated in the accompanying drawings.

Hereinafter, a method and system for semidefinite spectral clustering via convex programming according to an embodiment of the present invention will be described with reference to accompanying drawings.

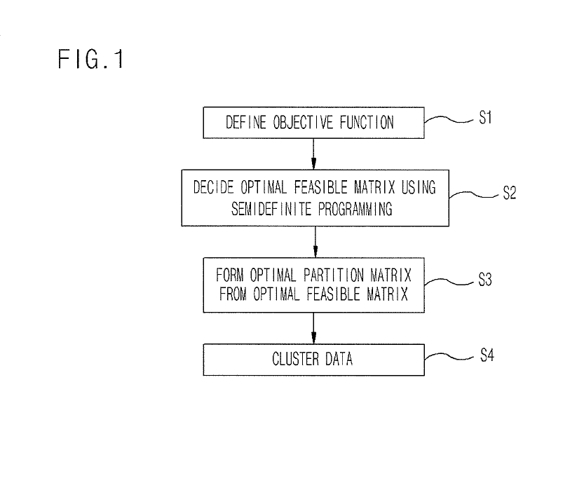

FIG. 1 is an overall flowchart illustrating a method for clustering data based on convex optimization according to an embodiment of the present invention.

That is, FIG. 1 shows an overall framework for an objective function related to graph multi-way partitioning and semidefinite spectral clustering from the corresponding objective function.

Although a well-known conventional spectral clustering method also uses graph partitioning that is an object of the present invention, the clustering method according to the present embodiment is different therefrom in a relaxation method. The conventional spectral clustering method using a spectral relaxation method groups data with adjacent clusters using the eigenvectors of an affinity matrix that represents similarity or a graph Laplacian generated from data. On the contrary, the semidefinite spectral clustering method according to the present embodiment clusters data using the eigenvectors of an optima feasible Solution that is obtained to determine whether given strong duality for semidefinite relaxation is satisfied or not. That is, since the semidefinite relaxation makes it possible to obtain a globally optimal solution in various combination problems such as graph multi-way partition, the semidefinite relaxation is used in the clustering method according to the present embodiment.

As shown in FIG. 1, the semidefinite spectral clustering method according to the present embodiment includes the object function defining step S1 for defining an object function, the optimization steps S2 and S3 for calculating a globally optimal solution through semidefinite programming for graph multi-way partitioning of the objective function, and the clustering step S4 for clustering data using a general clustering method with the globally optimal solution at step S4.

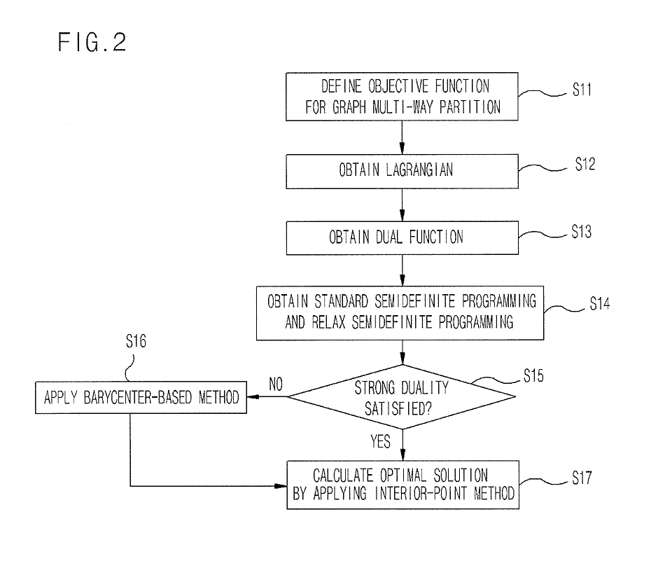

The optimization steps S2 and S3 are steps for obtaining the globally optimal solution that satisfies strong duality and an object function which are defined by a user. In more detail, an optimal feasible matrix is calculated using semidefinite programming at step S2, and an optimal partition matrix is calculated from the optimal feasible matrix at step S3. The optimization steps S2 and S3 will be described in more detail with reference to FIG. 2 in later.

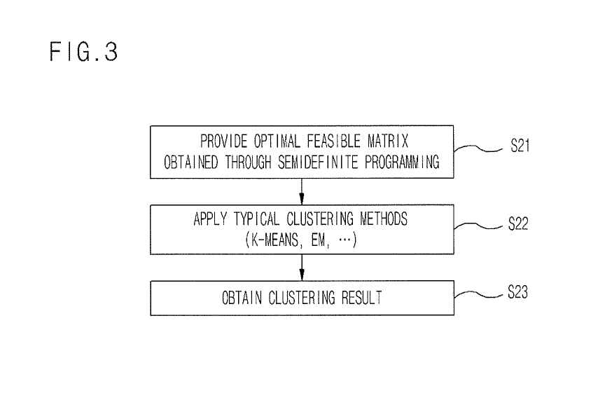

The clustering step S4 is the last step that clusters data using the optimal feasible matrix obtained from the optimization step. The clustering step S4 will be described in more detail with reference to FIG. 3.

The object function is defined as argₓ min tr(X^{T} LX).

Herein, X denotes an optimal partition matrix, L is a graph Laplacian, and T denotes the transpose of a matrix.

In order to cluster data, clustering methods including k-means, EM, or k-nn may be used.

The optimal feasible solution is defined based on the similarity or the difference between data. When the affinity matrix or the difference matrix of the data is generated, it is preferable to use a kernel function. Herein, the object of the optimization is to obtain the optimal feasible solution that satisfies the given strong duality. All solutions in a range of satisfying the given strong duality are feasible solutions, and one having the height value or the smallest value among the feasible solutions is the optimal feasible solution. It is preferable to extract feature points from the data for generating the affinity matrix and the difference matrix of the data. It is further preferable to apply the affinity matrix and the difference matrix to identical data or different data.

FIG. 2 is a flowchart illustrating the optimization step using semidefinite programming for obtaining an optimal feasible matrix in the method for clustering data using convex optimization according to an embodiment of the present invention.

The flowchart shown in FIG. 2 is a framework corresponding to the steps S2 and S3 of FIG. 1, which illustrates the step for calculating a globally optimal feasible matrix using semidefinite programming that is one of convex optimization methods.

As shown in FIG. 2, Lagrangian that satisfies the objective function and the strong duality defined by a user is obtained at steps S11 and S12, and a dual function is obtained based on the obtained Lagrangian at step S13. Then, a standard SDP form of basic semidefinite program is obtained using the obtained dual function and the other features such as self-duality and minmax inequality at step S14.

Herein, it is determined whether a relaxed standard semidefinite programming satisfies the strong duality or not at step S15. Herein, the relaxed standard SDP is a function relaxed through semidefinite programming which is one of convex programs. If the strong duality is not satisfied by the relaxed stand SDP, the optimal solution is obtained based on a barycenter-based method using the barycenter matrix of convex hull for partition matrices at step S16. If the strong duality is satisfied by the relaxed stand SDP, the optimal solution is calculated using an interior-point method that is one of Newton's methods as a technique for solving a linear equality constrained optimization problem at step S17. Herein, the interior-point method solves an optimization problem with linear equality and inequality constraints by reducing it to a sequence of linear equality constrained problems.

FIG. 3 is a flowchart illustrating the clustering step from the optimal feasible matrix in the method for clustering data using convex optimization according to an embodiment of the present invention.

The flowchart shown in FIG. 3 is framework corresponding to the clustering step S4 in FIG. 1. As shown in FIG. 3, the clustering result is obtained at step S23 by applying conventional clustering methods such as k-means at step S22 from the optimal feasible solution obtained through the semidefinite programming at step S21.

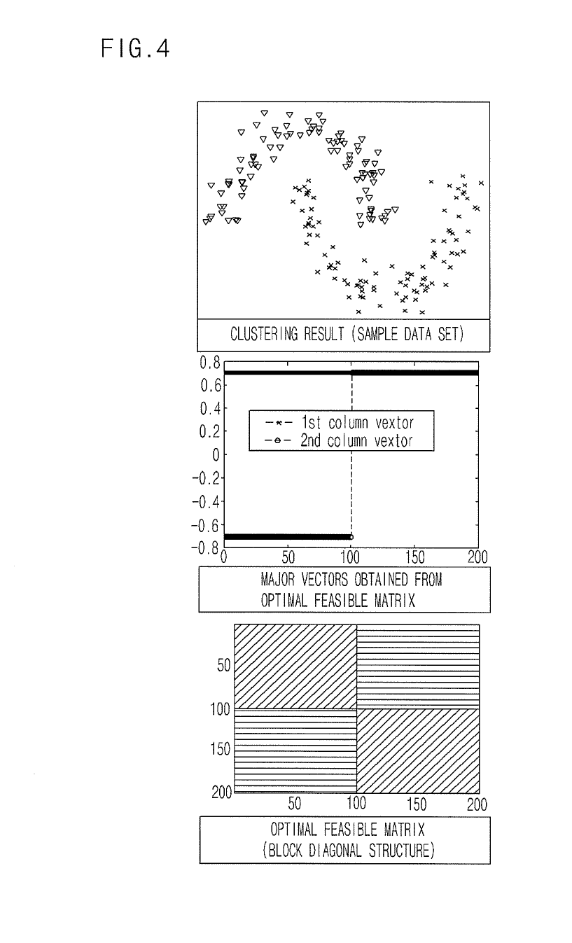

FIG. 4 is a diagram illustrating a simulation result for clustering data for graph multi-way partition that satisfies uniform distribution strong duality defined by a user based on FIG. 1 to FIG. 3.

A clustering simulation is performed by making the structure of matrix directly related to the generation of eigenvector to have a block diagonal structure using the semidefinite relaxation and forming principle vectors, the 1^{st} column vector, and the 2^{nd} column vector, obtained from the optimal feasible matrix, and the clustering result of the clustering simulation (sample data set) is illustrated in FIG. 4. In FIG. 4, 7 and X are used to easily distinguish each clustered data. Like the clustering simulation results shown in FIG. 4, the method for semidefinite spectral clustering based on convex optimization according to the present embodiment can provide the reliable clustering performance.

It will be apparent to those skilled in the art that various modifications and variations can be made in the present invention. Thus, it is intended that the present invention covers the modifications and variations of this invention provided they come within the scope of the appended claims and their equivalents.

As described above, the method for clustering data using convex optimization according to the present invention can be used in various fields where vast data are classified and analyzed. Such an automation process can save huge resources such as time and man power. Also, the method for clustering data using convex optimization according to the present invention can simultaneously cluster not only homogenous data but also heterogeneous data. Therefore, useful data can be provided to a user. Furthermore, the method for clustering data using convex optimization according to the present invention can provide the reliable clustering performance by overcoming the heuristic limitation of the conventional clustering methods through the convex optimization.

What is claimed is:

1. A method for clustering data based on convex optimization comprising the steps of:
obtaining an optimal feasible solution that satisfies given strong duality using convex optimization for an objective function; and
clustering data by extracting eigenvalue from the obtained optimal feasible solution.

2. The method of claim 1, wherein semidefinite relaxation is used as the convex optimization.

3. The method of claim 2, wherein semidefinite relaxation includes the steps of:
a) obtaining a dual function by obtaining a Lagrangian that satisfy the objective function and the strong duality;
b) determining whether the storing duality is satisfied by relaxed standard semidefinite programming obtained by relaxing the semidefinite programming; and
c) obtaining an optimal partition matrix through an interior-point method if the strong duality is satisfied.

4. The method of claim 3, wherein an optimal partition matrix is calculated using a barycenter-based method with a barycenter matrix of a convex hull for partition matrices if the strong duality is not satisfied.

5. The method of anyone of claims 3 and 4, wherein the objective function is argₓ min tr(X^{T} LX), where X denotes an optimal partition matrix, L is a graph Laplacian, and T denotes the transpose of a matrix.

6. The method of claim 1, wherein clustering methods including k-means, EM, and k-nn are applied for clustering.

7. The method of claim 1, wherein the optimal feasible solution defines similarity and difference between data.

8. The method of claim 1, wherein a kernel function is used when an affinity matrix or a difference matrix of the data is generated.

9. The method of claim 8, wherein feature points are extracted from the data to generate the affinity matrix and the difference matrix of the data.

10. The method of anyone of claims 7 to 9, wherein the affinity matrix or the difference matrix is applied to homogenous data or heterogeneous data.
